(19) United States
(12) Patent Application Publication
(10) Pub. No.: US 2024/0382951 A1
(43) Pub. Date: Nov. 21, 2024

(54) FLUID HANDLING DEVICE

(71) Applicant: Enplas Corporation, Saitama (JP)

(72) Inventors: Tomoki NAKAO, Saitama (JP); Makoto OGANE, Saitama (JP); Yasuhiro MOCHIDUKI, Saitama (JP); Shota TAKAMATSU, Saitama (JP)

(73) Assignee: Enplas Corporation, Saitama (JP)

(21) Appl. No.: 18/664,398

(22) Filed: May 15, 2024

(30) Foreign Application Priority Data
May 17, 2023 (JP) 2023-081473

(51) Int. Cl. B01L 3/00

(52) U.S. Cl. CPC B01L 3/502707; B01L 2200/025

(57) ABSTRACT

A fluid handling device of the present invention includes a first molded article that includes a first through hole. The fluid handling device includes a burr prevention portion, extending in the circumferential direction of the first through hole, on the inner peripheral surface of the first through hole.

### CROSS REFERENCE TO RELATED APPLICATIONS

This application claims the benefit of priority of Japanese Patent Application No. 2023-81473, filed on May 17, 2023, the disclosure of which including the specification, drawings and abstract is incorporated herein by reference in its entirety.

### TECHNICAL FIELD

The present invention relates to a fluid handling device.

### BACKGROUND ART

Fluid handling devices that include molded articles including through holes are known. Through holes formed in molded articles may be used for various purposes. For example, a through hole may be used as a channel, through which liquid flows, by closing the opening of the through hole, and a through hole may be used as a housing part for storing liquid. In addition, a through hole may be used for positioning by inserting a positioning pin into the through hole.

For example, Patent Literature (hereinafter, referred to as PTL) 1 discloses a microchannel sheet formed by combining members including such through holes.

### CITATION LIST

### Patent Literature

PTL 1
WO 2013/088913

### SUMMARY OF INVENTION

### Technical Problem

FIG. 1 is a cross-sectional view schematically illustrating a mode of a method for molding a molded article including a through hole. For molding molded article 40 including through hole 41 as illustrated in the lower drawing of FIG. 1, first, a mold is prepared, in which pin 30 passing through second mold 20 abuts against first mold 10, in a cavity formed of first mold 10 and second mold 20 as illustrated in the upper drawing of FIG. 1. As illustrated in the middle drawing of FIG. 1, a molding material is then poured into a cavity formed from first mold 10, second mold 20, and pin 30, within the mold. As illustrated in the lower drawing of FIG. 1, the mold is then opened and molded article 40 in which through hole 41 is formed is taken out.

When the molding material enters a space between first mold 10 and pin 30, burr 42 protruding from the inner peripheral surface of through hole 41 may be generated as illustrated in lower drawing of FIG. 1.

An object of the present invention is to provide a fluid handling device including a molded article with a through hole, in which the generation of a burr is prevented or reduced (herein simply referred to as “prevented”).

### Solution to Problem

The present invention relates to the following fluid handling devices.
[1] A fluid handling device, including: a first molded article that includes a first through hole, wherein the fluid handling device includes a burr prevention portion on an inner peripheral surface of the first through hole, the burr prevention portion extending in a circumferential direction of the first through hole.
[2] The fluid handling device according to [1], wherein the burr prevention portion is spaced apart from an opening of the first through hole.
[3] The fluid handling device according to [1] or [2], wherein the burr prevention portion extends over entire circumference of the first through hole in the circumferential direction.
[4] The fluid handling device according to any one of [1] to [3], further including: a second member joined to the first molded article, wherein one opening of the first through hole is closed by the second member.
[5] The fluid handling device according to any one of [1] to [4], further including: a second molded article joined to the first molded article, the second molded article including a second through hole, wherein the first through hole and the second through hole communicate with each other.
[6] The fluid handling device according to [5], wherein the first through hole and the second through hole are positioning holes.

### Advantageous Effects of Invention

The present invention can provide a fluid handling device including a molded article with a through hole, in which the generation of a burr is prevented.

### BRIEF DESCRIPTION OF DRAWINGS

FIG. 1 is a cross-sectional view for explaining problems during the molding of a molded article including a through hole;

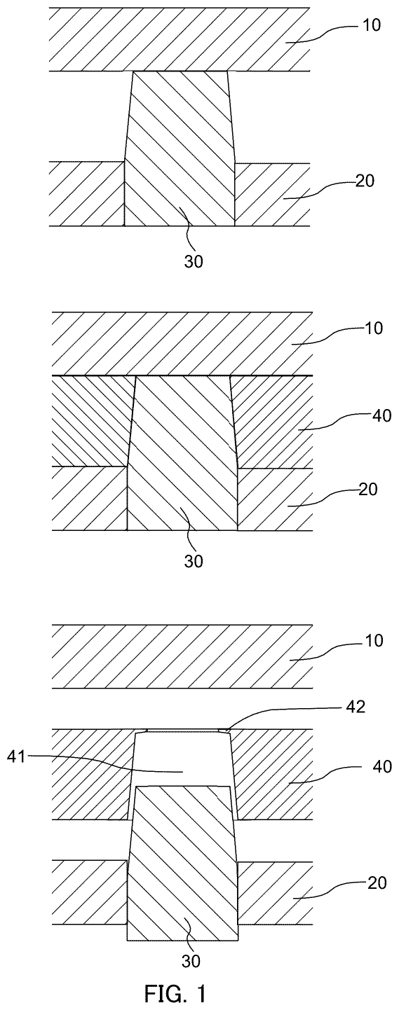

FIG. 2 is a cross-sectional view illustrating a mode during the formation of a through hole of a fluid handling device according to the present embodiment;

FIGS. 3A to 3D illustrate the fluid handling device according to the present embodiment;

FIGS. 4A to 4D illustrate a first molded article;

FIGS. 5A to 5D illustrate a second molded article;

FIG. 6A is a cross-sectional view illustrating a mode during the positioning of a molded article including a through hole, and FIG. 6B is a plan view illustrating a mode after the positioning;

FIG. 7 is a cross-sectional view illustrating a mode during the formation of a through hole of a fluid handling device according to a variation; and

FIGS. 8A to 8D illustrate the fluid handling device according to the variation.

### DESCRIPTION OF EMBODIMENTS

Hereinafter, an embodiment according to the present invention will be described in detail with reference to the drawings.

### EMBODIMENT

### Molding of Molded Article including Through Hole

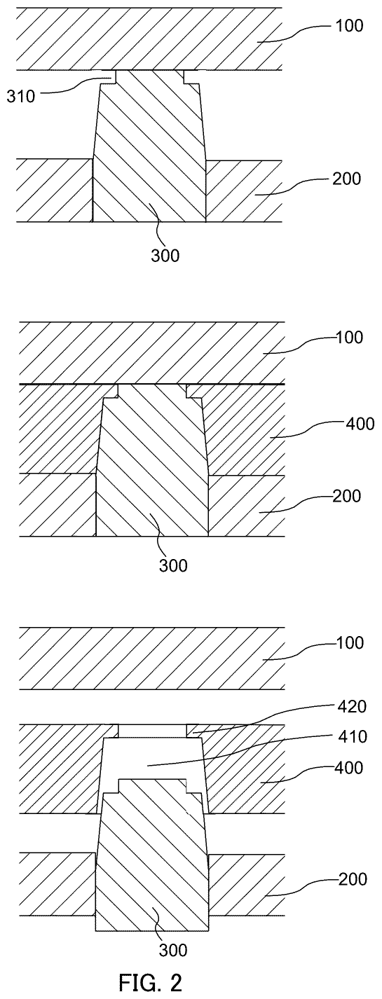

FIG. 2 illustrates one mode of a method for forming a through hole in a fluid handling device according to an embodiment of the present invention, in which the generation of a burr is prevented.

In the present embodiment, as illustrated in the upper drawing of FIG. 2, a mold is prepared, in which pin 300 passing through second mold 200 abuts against first mold 100, in a cavity formed of first mold 100 and second mold 200. Pin 300 includes burr prevention or reduction recess (herein simply referred to as “burr prevention recess”) 310 having a shape of a notch at one end on the side that abuts against first mold 100.

As illustrated in the middle drawing of FIG. 2, a molding material is then poured into the cavity. The molding material enters a cavity formed from burr prevention recess 310 and first mold 100. The heat of the molding material that has entered the cavity is quickly absorbed by pin 300 and first mold 100, so that the molding material hardens quickly. Therefore, the molding material is prevented from entering a space between first mold 100 and pin 300, thereby preventing the generation of burrs.

As illustrated in the lower drawing of FIG. 2, the mold is then opened and molded article 400 in which through hole 410 is formed is taken out. Molded article 400 includes burr prevention or reduction portion (herein simply referred to as “burr prevention portion”) 420 that is complementary to the cavity formed from burr prevention recess 310 and first mold 100. In through hole 410 of molded article 400 including burr prevention portion 420, generation of burrs is prevented. Examples of the molding material include resins, thermoplastic resins, thermosetting resins, elastomers, and glass.

### Fluid Handling Device

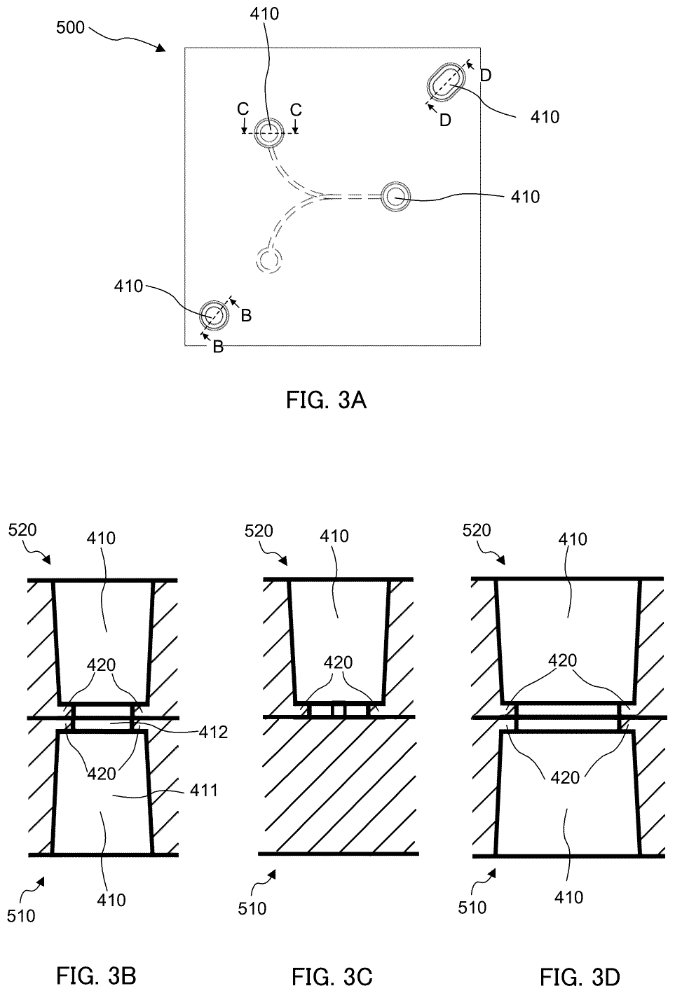

FIG. 3A is a plan view of fluid handling device 500 including such a through hole 410 according to an embodiment of the present invention. FIG. 3B is a cross-sectional view of through hole 410 taken along line B-B in FIG. 3A, FIG. 3C is a cross-sectional view of through hole 410 taken along line C-C in FIG. 3A, and FIG. 3D is a cross-sectional view of through hole 410 taken along line D-D in FIG. 3A.

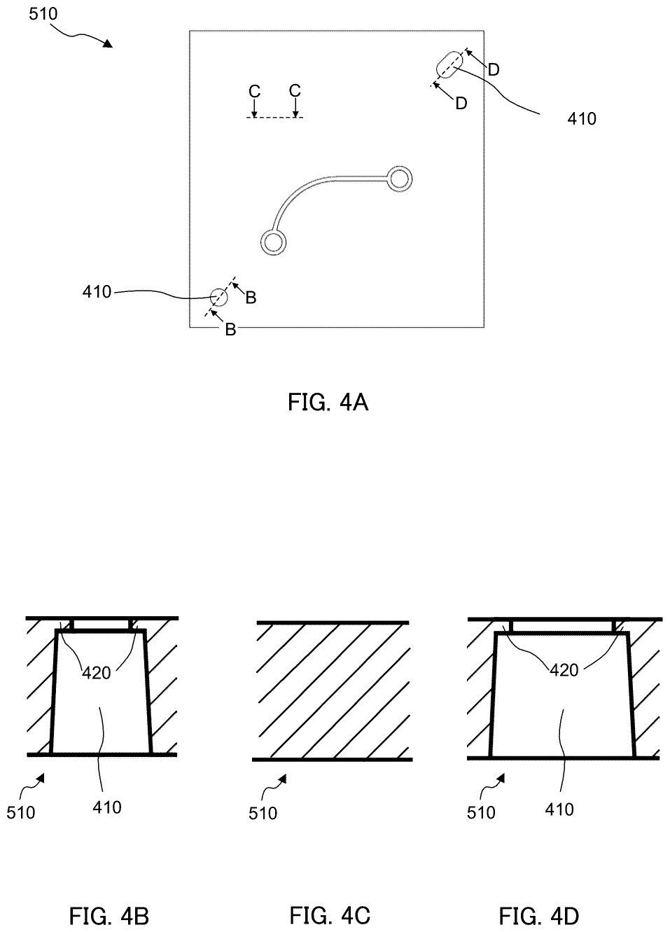

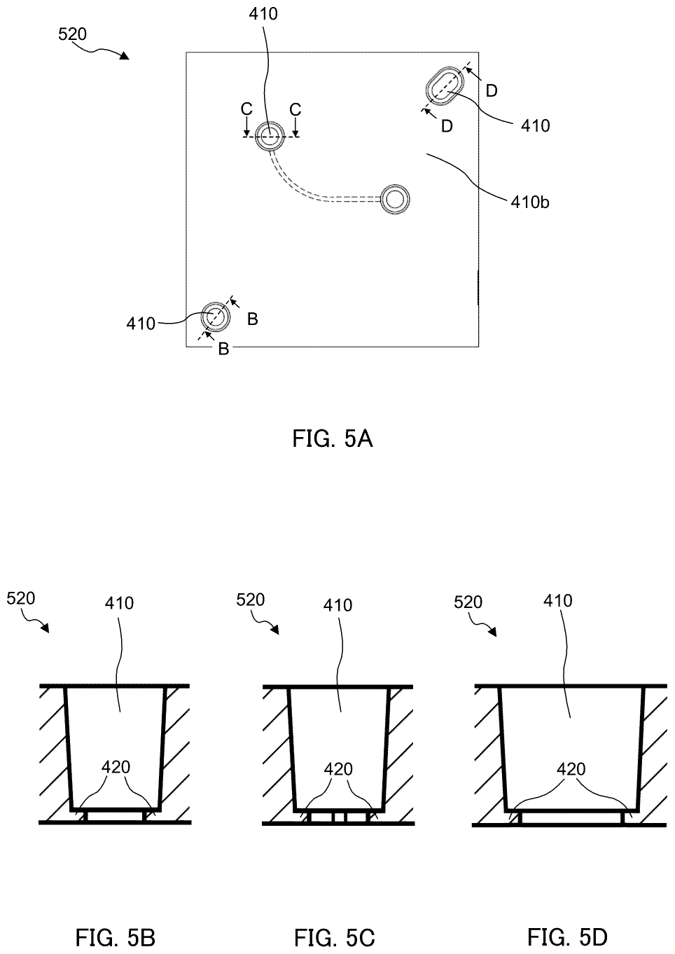

Fluid handling device 500 includes first molded article 510 illustrated in FIG. 4A and second molded article 520 illustrated in FIG. 5A. Specifically, in fluid handling device 500, first molded article 510 and second molded article 520 are stacked (joined to each other).

FIG. 4A is a plan view of first molded article 510, FIG. 4B is a cross-sectional view of through hole 410 taken along line B-B in FIG. 4A, FIG. 4C is a cross-sectional view of through hole 410 taken along line C-C in FIG. 4A, and FIG. 4D is a cross-sectional view of through hole 410 taken along line D-D in FIG. 4A.

Similarly, FIG. 5A is a plan view of second molded article 520, FIG. 5B is a cross-sectional view of through hole 410 taken along line B-B in FIG. 5A, FIG. 5C is a cross-sectional view of through hole 410 taken along line C-C in FIG. 5A, and FIG. 5D is a cross-sectional view of through hole 410 taken along line D-D in FIG. 5A.

As illustrated in FIGS. 3B and 3D, in fluid handling device 500, through hole 410 of first molded article 510 and through hole 410 of second molded article 520 may communicate with each other. The two through holes communicating each other in such a manner may be used, for example, as a positioning hole that allows insertion of a positioning member for positioning. Alternatively, through hole 410 may be used alone as a positioning hole without communicating to another through hole.

In addition, in fluid handling device 500, at least one opening of through hole 410 may be closed by another member as illustrated in FIG. 3C. Examples of another member (second member) include molded articles and films. Through hole 410 with at least one opening thereof is closed may be used, for example, as a housing part or a channel for fluid (for example, liquid or gas).

In the present embodiment, it is preferable that through hole 410 of the first molded article and through hole 410 of second molded article 520 communicate with each other at the opening on the side closer to burr prevention portions 420. In addition, of the openings of through hole 410, the opening on the side closer to burr prevention portion 420 is preferably closed with another member. As described above, in the present embodiment, the generation of a burr is prevented at the opening on the side closer to burr prevention portion 420. Therefore, the following can be prevented: a burr changes the inner diameter of a through hole, making it impossible to insert a positioning pin, and a channel is clogged caused by a foreign matter adhering thereto due to a burr falling off or a burr falling into the channel. Therefore, this side of the opening of the molded article is excellent as a side for connecting with another member, for example, for causing the through hole to communicate with another through hole or closing the through hole.

The shape of burr prevention portion 420 is not limited as long as the shape is resulted from designing the cavity of a mold so as to prevent the generation of burrs. In the present embodiment, the shape of the burr prevention portion viewed in a cross section including the central axis of through hole 410 is such that the burr prevention portion protrudes from the inner peripheral surface of through hole 410 toward the center of through hole 410 (for example, a protruding rectangular shape).

Burr prevention portion 420 may include a portion flush with the outer surface of the molded article, but burr prevention portion 420 does not need to include such a portion. In other words, the burr prevention portion does not need to be spaced apart from the opening that opens onto the outer surface of the molded article, but the burr prevention portion may be spaced apart from the opening of a through hole. In the present embodiment, burr prevention portion 420 includes a portion flush with the outer surface of the molded article and is not spaced apart from the opening, as illustrated in FIGS. 4B, 4D, and 5B to 5D. That is, in the present embodiment, burr prevention portion 420 protrudes so as to narrow the opening of through hole 410 that opens onto the outer surface of the molded article.

The size of burr prevention portion 420 may be appropriately designed to have a burr prevention effect. A burr is considered to be generated according to the type of molding material, the temperature and viscosity of the molding material poured into a mold, the pressure when the molding material is poured into the mold, and the size of a gap between first mold 100 and pin 300 abutting against first mold 100. Therefore, burr prevention portion 420 may be appropriately designed according to the above.

In the present embodiment, the length of burr prevention portion 420 in the protruding direction thereof is 5 to 25% of the diameter of a through hole (for example, when the diameter of the through hole is 1 to 10 mm, the length is approximately 0.05 to 2.5 mm, preferably 0.1 to 2 mm), and the thickness of the burr prevention portion (the length in the axial direction of the through hole) is approximately ½ to 2 times the length of the burr prevention portion in the protruding direction (for example, thickness of 0.1 to 2 mm). In addition, in the present embodiment, the thickness of the burr prevention portion is approximately constant. In addition, the ratio of the length of burr prevention portion 420 in the protruding direction to the thickness of the burr prevention portion is preferably such that when the length in the protruding direction is 1, the thickness is approximately ½ to 2.

As illustrated in FIGS. 3B to 3D, burr prevention portion 420 may have any configuration as long as the burr prevention portion is on the inner peripheral surface of through hole 410 and extends in the circumferential direction of through hole 410. Burr prevention portion 420 may extend over the entire circumference of the inner peripheral surface in the circumferential direction, or may extend on a part of the inner peripheral surface in the circumferential direction. In the present embodiment, burr prevention portion 420 extends over the entire circumference of the inner peripheral surface in the circumferential direction.

The shape of through hole 410 in plan view is not limited. In the present embodiment, the shape of through hole 410 in plan view is a circular shape (for example, a perfect circle shape) as illustrated in FIG. 3A, or an elliptical shape having two opposing straight lines and two opposing curved lines (for example, a circular arc or a semicircle).

In the present embodiment, the three-dimensional shape of through hole 410 includes a portion that is complementary to the shape of pin 300 including a draft angle and burr prevention recess 310. In other words, in the present embodiment, through hole 410 includes tapered shape portion 411 becoming narrower toward its end (tapered end) and first portion 412 surrounded by the protruding burr prevention portion 420 as illustrated in FIG. 3B. The first portion is located at the tip of the tapered end of the tapered shape portion and is thinner than the thinnest part of the tapered shape portion. In the present embodiment, for example, tapered shape portion 411 has a truncated cone shape, and first portion 412 surrounded by the burr prevention portion has a cylindrical shape.

In the present embodiment, the length of tapered shape portion 411 in the axial direction of through hole 410 is, for example, approximately 0.5 to 20 mm, and the length of first portion 412 (surrounded by burr prevention portion 420) in the axial direction is approximately 0.1 to 2 mm. In addition, in the axial direction, the ratio of the length of tapered shape portion 411 to the length of first portion 412 surrounded by burr prevention portion 420 is preferably such that when the length of tapered shape portion 411 is 1,the length of first portion 412 is approximately 0.01 to 0.2.

In plan view, through hole 410 may be disposed at any position in fluid handling device 500 or a molded article. Through holes 410 are disposed in the present embodiment as follows as illustrated in FIGS. 3A, 4A and 5A: through hole 410 with a circular opening and through hole 410 with an elliptical opening are respectively disposed at two opposing corners of the rectangular fluid handling device 500 or the molded article. The two through holes 410 disposed in this manner may be used for positioning fluid handling device 500 or first molded article 510 and second molded article 520.

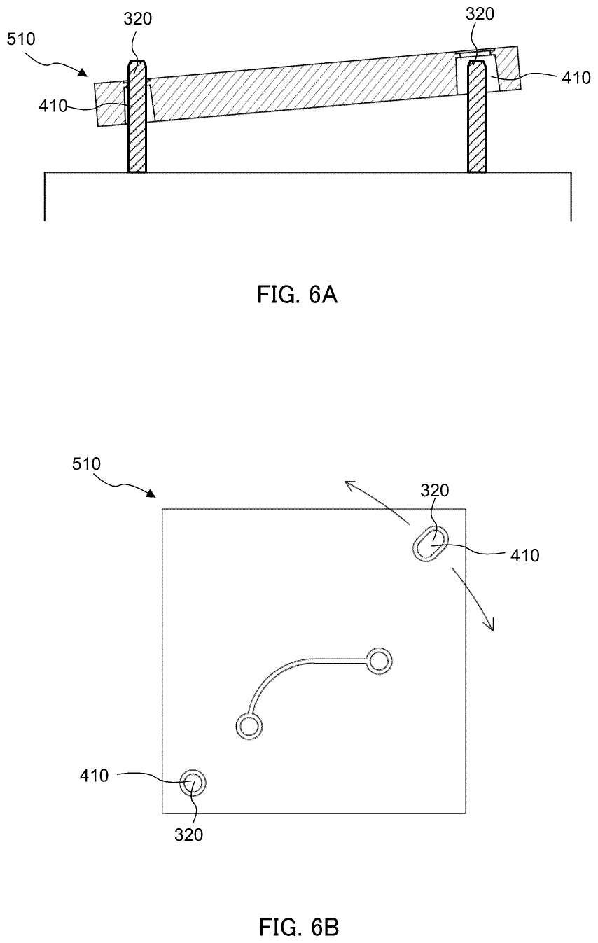

FIG. 6A is a cross-sectional view illustrating the state during the positioning of first molded article 510 by inserting positioning pins 320 into (or through) through holes 410 of first molded article 510. FIG. 6B is a plan view illustrating the state after positioning pins 320 are inserted into through holes 410 and first molded article 510 is positioned. In FIG. 6A, the configuration of first molded article 510 other than through holes 410 is omitted.

As illustrated in FIG. 6B, in first molded article 510 in plan view, the through hole with a circular opening (the through hole on the left side in FIG. 6A) and the through hole with an elliptical opening (the through hole on the right side in FIG. 6A) are respectively disposed at two opposing corners. As illustrated in FIG. 6A, as one of the two through holes 410 has a substantially elongated cylindrical shape, it becomes easy to insert positioning pins 320 into through holes 410 even when first molded article 510 is tilted, allowing easier positioning of first molded article 510.

FIG. 6B is a plan view illustrating the state after positioning pins 320 are inserted into through holes 410 and first molded article 510 is positioned. As illustrated in FIG. 6B, displacement of first molded article 510 in the rotational direction can be restricted by through hole 410 with the circular opening and through hole 410 with the elliptical opening respectively disposed at the two opposing corners in the rectangular first molded article 510 in plan view. Specifically, the width of the ellipse (of the two-opposing straight line portion of the ellipse) can restrict displacement in the rotational direction, thereby increasing positional accuracy. First molded article 510, which includes through hole 410 with the circular opening and through hole 410 with the elliptical opening respectively disposed at the opposing corners as illustrated in FIGS. 6A and 6B, is effective in making positioning easier as described above and maintaining the same positional accuracy as a molded article including two through holes each with a circular opening.

### Effect

The generation of a burr in the through hole of the molded article is prevented in fluid handling device 500 according to the present embodiment. This configuration prevents the following: a burr changes the inner diameter of the through hole to prevent a positioning pin from entering the through hole. Therefore, it becomes easier to position the fluid handling device at the designed position. In addition, a burr protruding from the outer surface of a molded article may prevent the molded article from being combined with another member as designed to form a fluid handling device. However, in the present embodiment, the generation of burrs is prevented, and therefore, the following is prevented: the molded article and another member cannot be combined as designed in the fluid handling device.

### Variation

A fluid handling device according to the variation can be expected to solve the problems that may occur in fluid handling device 500 according to the above embodiment. That is, in fluid handling device 500 according to the above embodiment, burr prevention portion 420 protruding from the inner peripheral surface of through hole 410 may curl up at the outer surface of the molded article when a strong force is applied from the outside. However, the variation can be expected to prevent the occurrence of such a problem.

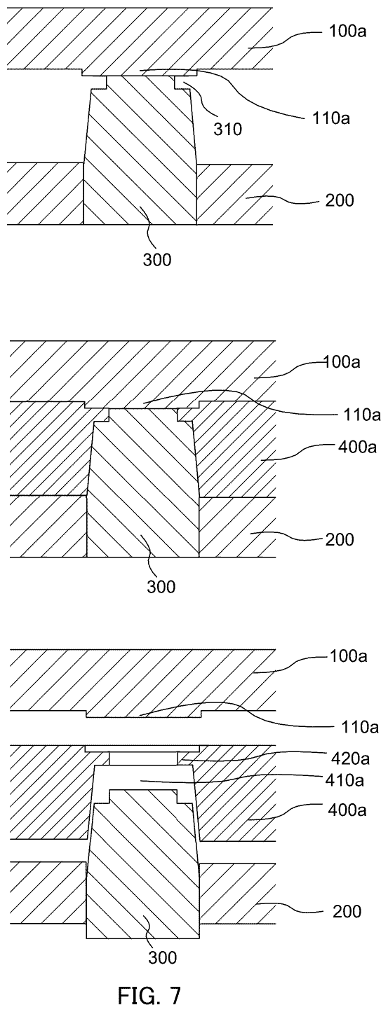

FIG. 7 illustrates a mode during the formation of a through hole of the fluid handling device according to the variation. In the variation, the same components as those in the embodiment are given the same reference numerals, and the description thereof will be omitted.

In the variation, as illustrated in the upper drawing of FIG. 7, a mold is prepared, in which pin 300 passing through second mold 200 abuts against first mold 100a, in a cavity formed of first mold 100a and second mold 200. First mold 100a includes landing pad 110a that protrudes toward pin 300 at a location where pin 300 abuts against.

As illustrated in the middle drawing of FIG. 7, a molding material is then poured into the cavity formed from first mold 100a, second mold 200, and pin 300, within the mold. The molding material enters a cavity formed from burr prevention recess 310 and landing pad 110a.

As illustrated in the lower drawing of FIG. 7, the mold is then opened and molded article 400a in which through hole 410a is formed is taken out. Molded article 400a includes burr prevention portion 420a that is complementary to the cavity formed from burr prevention recess 310 and landing pad 110a of first mold 100a. This burr prevention portion 420a protrudes from the inner peripheral surface of through hole 410a, but is spaced apart from the opening of the through hole. Therefore, even when a strong force is applied from the outside to cause deformation, burr prevention portion 420a is prevented from protruding from the outer surface of molded article 400a.

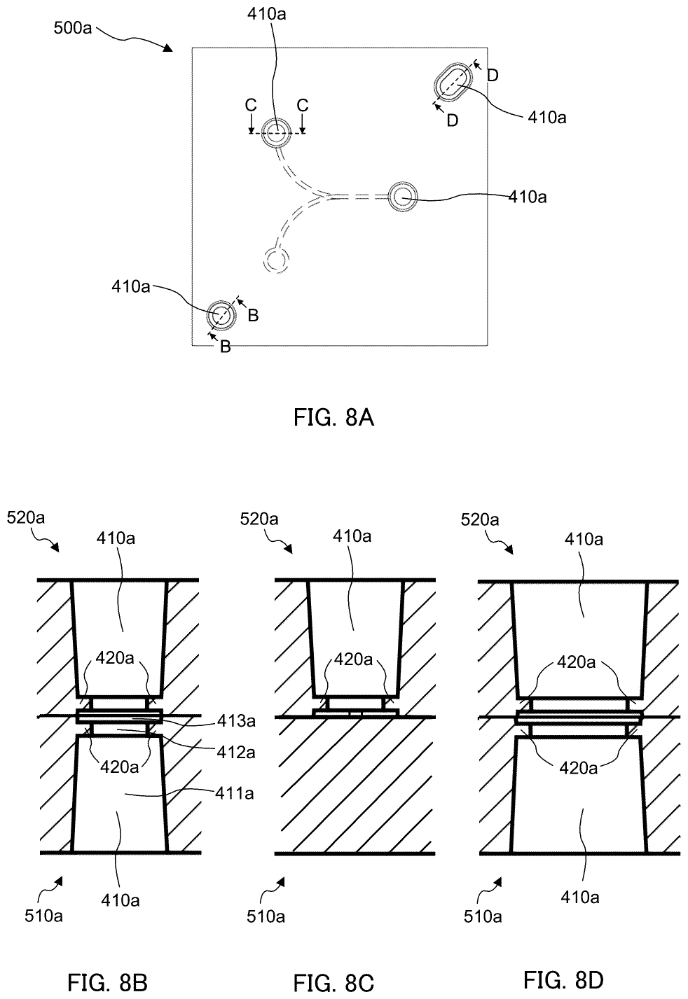

FIG. 8A illustrates fluid handling device 500a according to the variation. FIG. 8B is a cross-sectional view of through hole 410a taken along line B-B in FIG. 8A, FIG. 8C is a cross-sectional view of through hole 410a taken along line C-C in FIG. 8A, and FIG. 8D is a cross-sectional view of through hole 410a taken along line D-D in FIG. 8A. As illustrated in FIGS. 8B to 8D, fluid handling device 500a includes first molded article 510a with through holes 410a and second molded article 520a with through holes 410a. In the same manner as in the embodiment, in fluid handling device 500a, first molded article 510a and second molded article 520a are stacked (joined to each other).

Burr prevention portion 420a may be at any position as long as the burr prevention portion is spaced apart from the opening of through hole 410a but is preferably disposed at a position such that the burr prevention portion does not protrude from the surface of the molded article even when the deformation is caused. Specifically, burr prevention portion 420a (one of the surfaces of burr prevention portion 420a, the surface on the side closer to the opening) is preferably spaced apart from the opening by approximately 0.01 to 3 mm in the axial direction of the through hole.

The size of burr prevention portion 420a may be appropriately designed to have a burr prevention effect. In the present variation, the length of burr prevention portion 420a in the protruding direction thereof is 5 to 25% of the diameter of a through hole (for example, when the diameter of the through hole is 1 to 10 mm, the length is approximately 0.05 to 2.5 mm, preferably 0.1 to 2 mm), and the thickness of burr prevention portion 420a (the length in the axial direction of the through hole) is approximately ½ to 2 times the length of the burr prevention portion in the protruding direction (for example, thickness of 0.1 to 2 mm). In addition, in the present variation, the thickness of burr prevention portion 420a is approximately constant. In addition, the ratio of the length of burr prevention portion 420a in the protruding direction to the thickness of the burr prevention portion is preferably such that when the length in the protruding direction is 1, the thickness is approximately ½ to 2. In addition, from the view point of preventing the protrusion of burr prevention portion 420a from the surface of the molded article, the length of burr prevention portion 420a in the protruding direction is preferably approximately 0.1 to 10 when the distance between the opening of the molded article (outer surface of the molded article) and the surface of burr prevention portion 420a on the side closer to the opening is 1.

In the present variation, the three-dimensional shape of through hole 410a including burr prevention portion 420a includes a portion that is complementary to the shape of pin 300 including a draft angle and burr prevention recess 310 and first mold 100a including landing pad 110a. In other words, in the present variation, through hole 410a includes tapered shape portion 411a becoming narrower toward its end (tapered end), first portion 412a surrounded by the protruding burr prevention portion 420a, and second portion 413a in this order as illustrated in FIG. 8B. The first portion is located at the tip of the tapered end of tapered shape portion 411a and is thinner than the thinnest part of tapered shape portion 411a, and the second portion is complementary to landing pad 110a and is thicker than first portion 412a surrounded by burr prevention portion 420a. In the present variation, for example, tapered shape portion 411a has a truncated cone shape, and first portion 412a and second portion 413a have a cylindrical shape.

In the present variation, in the axial direction of through hole 410a, the length of tapered shape portion 411a is, for example, approximately 0.5 to 20 mm, the length of first portion 412a is approximately 0.1 to 2 mm, and the length of second portion 413a is approximately 0.01 to 1 mm. In addition, when the length of tapered shape portion 411a in the axial direction is 1, the length of first portion 412a is preferably approximately 0.01 to 0.2, and the length of second portion 413a is preferably approximately 0.001 to 0.1.

In the present variation, features other than the above-described features of burr prevention portion 420a and through hole 410a may be the same as those in the embodiment.

### Effect

The molded article in the fluid handling device according to the variation has the effect of preventing the generation of burrs, in the same manner as in the embodiment. Further, in the molded article in the fluid handling device according to the variation, the burr prevention portion is spaced apart from the opening of the through hole. Therefore, even when a strong force is applied to the burr prevention portion, the protrusion of the burr prevention portion from the outer surface of the molded article is prevented. It is thus easier to stack molded articles as designed.

### INDUSTRIAL APPLICABILITY

The fluid handling device can be easily positioned at a designed position as the influence of burrs is reduced. Therefore, the present invention is particularly advantageous for positioning fluid handling devices that require high positional accuracy.

### REFERENCE SIGNS LIST

10, 100, 100a First mold
20, 200 Second mold
30, 300 Pin
40, 400, 400a Molded article
41, 410, 410a Through hole
42 Burr
110a Landing pad
310 Burr prevention recess
320 Positioning pin
411, 411a Tapered shape portion
412, 412a First portion
413a Second portion
420, 420a Burr prevention portion
500, 500a Fluid handling device
510, 510a First molded article
520, 520a Second molded article

1. A fluid handling device, comprising:
a first molded article that includes a first through hole, wherein
the fluid handling device includes a burr prevention portion on an inner peripheral surface of the first through hole, the burr prevention portion extending in a circumferential direction of the first through hole.

2. The fluid handling device according to claim 1, wherein the burr prevention portion is spaced apart from an opening of the first through hole.

3. The fluid handling device according to claim 1, wherein the burr prevention portion extends over entire circumference of the first through hole in the circumferential direction.

4. The fluid handling device according to claim 1, further comprising:
a second member joined to the first molded article, wherein
one opening of the first through hole is closed by the second member.

5. The fluid handling device according to claim 1, further comprising:
a second molded article joined to the first molded article, the second molded article including a second through hole, wherein
the first through hole and the second through hole communicate with each other.

6. The fluid handling device according to claim 5, wherein the first through hole and the second through hole are positioning holes.
